(19) United States
(12) Patent Application Publication
(10) Pub. No.: US 2022/0198137 A1
(43) Pub. Date: Jun. 23, 2022

(54) TEXT ERROR-CORRECTING METHOD, APPARATUS, ELECTRONIC DEVICE AND READABLE STORAGE MEDIUM

(71) Applicant: BEIJING BAIDU NETCOM SCIENCE AND TECHNOLOGY CO., LTD., Beijing (CN)

(72) Inventors: Jiawei LAI, Beijing (CN); Zhuobin DENG, Beijing (CN); Mengdi XU, Beijing (CN); Zhihong FU, Beijing (CN); Jingzhou HE, Beijing (CN)

(73) Assignee: BEIJING BAIDU NETCOM SCIENCE AND TECHNOLOGY CO., LTD., Beijing (CN)

(21) Appl. No.: 17/382,567

(22) Filed: Jul. 22, 2021

(30) Foreign Application Priority Data
Dec. 23, 2020 (CN) 202011537710.X

(51) Int. Cl. G06F 40/194; G06F 40/40

(52) U.S. Cl. CPC G06F 40/194; G06F 40/40

(57) ABSTRACT

The present disclosure provides a text error-correcting method, apparatus, electronic device and readable storage medium and relates to the field of natural language processing and deep learning. In the present disclosure, an implementation solution employed when performing text error correction is: obtaining a text to be processed, and an error-correcting type of the text to be processed; selecting a target error-correcting model corresponding to the error-correcting type; processing the text to be processed using the target error-correcting model, and regarding a processing result as an error-correcting result of the text to be processed. The present disclosure can enhance the flexibility and accuracy of text error correction.

### CROSS-REFERENCE TO RELATED APPLICATIONS

The present application claims the priority of Chinese Patent Application No. 202011537710.X, filed on Dec. 23, 2020, with the title of “Text error-correction method, apparatus, electronic device and readable storage media”. The disclosure of the above application is incorporated herein by reference in its entirety.

### TECHNICAL FIELD

The present disclosure relates to technical field of computers, and particularly to a text error-correcting method, apparatus, electronic device and readable storage medium in the field of natural language processing and deep learning technique.

### BACKGROUND

In practical application of an error-correcting technique, errors to be corrected may include many types such as shape-similar/pronunciation-similar errors, punctuation mark errors, collocation errors and grammatical errors.

In the prior art, when different types of errors are corrected, a commonly-used error-correcting manner is training an error-correcting model to achieve correction of many types of errors. When new errors to be corrected occur, the error-correcting model needs to be trained again, so that the flexibility in text error correction is undesirable.

### SUMMARY

A technical solution employed by the present disclosure to solve the technical problem is to provide a text error-correcting method, including: obtaining a text to be processed, and an error-correcting type of the text to be processed; selecting a target error-correcting model corresponding to the error-correcting type; processing the text to be processed using the target error-correcting model, and regarding a processing result as an error-correcting result of the text to be processed.

A technical solution employed by the present disclosure to solve the technical problem is to provide an electronic device, including: at least one processor; and a memory communicatively connected with the at least one processor; wherein the memory stores instructions executable by the at least one processor, and the instructions are executed by the at least one processor to enable the at least one processor to perform a text error-correcting method, wherein the method includes: obtaining a text to be processed, and an error-correcting type of the text to be processed; selecting a target error-correcting model corresponding to the error-correcting type; processing the text to be processed using the target error-correcting model, and regarding a processing result as an error-correcting result of the text to be processed.

A non-transitory computer readable storage medium with computer instructions stored thereon, wherein the computer instructions are used for causing a computer to perform a text error-correcting method, wherein the method includes: obtaining a text to be processed, and an error-correcting type of the text to be processed; selecting a target error-correcting model corresponding to the error-correcting type; processing the text to be processed using the target error-correcting model, and regarding a processing result as an error-correcting result of the text to be processed.

An embodiment of the present disclosure has the following advantages or advantageous effects: the present disclosure can improve the flexibility and accuracy of the text error correction. Since the technical means of obtaining the error-correcting type of the text to be processed while obtaining the text to be processed is employed, thereby using a target error-correcting model corresponding to the error-correcting type to process the text to be processed, the flexibility and accuracy of the text error correction can be enhanced on the premise of satisfying the user's different error-correcting demands.

Other effects of the above optional manners will be described below in conjunction with specific embodiments.

### BRIEF DESCRIPTION OF THE DRAWINGS

The figures are only intended to facilitate understanding the solutions, not to limit the present disclosure. In the figures,

FIG. 1 illustrates a schematic diagram of a first embodiment according to the present disclosure;

FIG. 2 illustrates a schematic diagram of a second embodiment according to the present disclosure;

FIG. 3 illustrates a schematic diagram of a third embodiment according to the present disclosure;

FIG. 4 illustrates a block diagram of an electronic device for implementing a text error-correcting method according to embodiments of the present disclosure.

### DETAILED DESCRIPTION

Exemplary embodiments of the present disclosure are described below with reference to the accompanying drawings, include various details of the embodiments of the present disclosure to facilitate understanding, and should be considered as being only exemplary. Therefore, those having ordinary skill in the art should recognize that various changes and modifications can be made to the embodiments described herein without departing from the scope and spirit of the application. Also, for the sake of clarity and conciseness, depictions of well-known functions and structures are omitted in the following description.

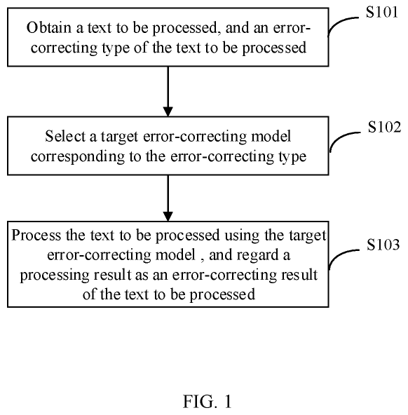

FIG. 1 illustrates a schematic diagram of a first embodiment according to the present disclosure. As shown in FIG. 1, a text error-correcting method according to the present embodiment may specifically include the following steps:

S101: obtaining a text to be processed, and an error-correcting type of the text to be processed;

S102: selecting a target error-correcting model corresponding to the error-correcting type;

S103: processing the text to be processed using the target error-correcting model, and regarding a processing result as an error-correcting result of the text to be processed.

According to the text error-correcting method according to the present embodiment, different error-correcting models can be invoked for different error-correcting types by obtaining the error-correcting type of the text to be processed while obtaining the text to be processed, thereby using a target error-correcting model corresponding to the error-correcting type to process the text to be processed to obtain an error-correcting result. The flexibility and accuracy of the text error correction can be enhanced on the premise of satisfying the user's different error-correcting demands.

In the present embodiment, when S101 of obtaining the text to be processed is performed, a text input by the user may be regarded as the text to be processed, and or a text conversion result of a speech input by the user may be regarded as the text to be processed.

In the present embodiment, when S101 of obtaining the text to be processed is performed, the error-correcting type of the text to be processed may also be obtained. The obtained error-correcting type may be one type or multiple types. The error-correcting type obtained by performing S101 in the present embodiment may include at least one of shape-similar/pronunciation-similar error, punctuation mark error, collocation error, grammatical error etc.

In the present embodiment, when S101 of obtaining the error-correcting type of the text to be processed is performed, the error-correcting type input by the user or selected by the user may be regarded as the error-correcting type of the text to be processed, or after the error-correcting type of the text to be processed is recognized, a recognition result may be regarded as the error-correcting type of the text to be processed.

It may be appreciated that in the present embodiment, a pre-trained recognition model may be used to implement recognition of the error-correcting type of the text to be processed. The recognition model can output the error-correcting type of the text according to the input text.

In the present embodiment, after the text to be processed and the error-correcting type of the text to be processed are obtained by performing S101, S102 is performed to select a target error-correcting model corresponding to the obtained error-correcting type. The selected target error-correcting model in the present embodiment is preset. Each target error-correcting model corresponds to an error-correcting type. Different target error-correcting models are only intended to correct one corresponding type of error in the text.

In the present embodiment, when S102 is performed to select a target error-correcting model corresponding to the obtained error-correcting type, an optional implementation that may be employed is: taking an error-correcting model corresponding to the obtained error-correcting type as the target error-correcting model, according to a preset type-model correspondence relationship table.

It may be appreciated that in the present embodiment, the number of target error-correcting models selected by performing S102 is equal to the number of error-correcting types of the text to be processed obtained by performing S101. If there is one type of error-correcting type, one target error-correcting model is selected in the present embodiment. If there are a plurality of error-correcting types, a plurality of target error-correcting models will be selected, with each target error-correcting model corresponding to a different error-correcting type.

In the present embodiment, if it is determined that the same error-correcting type corresponds to a plurality of error-correcting models when S102 is performed, one error-correcting model may be randomly selected from the plurality of error-correcting models as the target error-correcting model corresponding to the error-correcting type.

Since different texts will also correspond to different scenes, when error correction is performed for texts in different scenes, error-correcting results of the texts will also be related to the scenes corresponding to the texts.

In the present embodiment, in order to improve the accuracy of the selected target error-correcting model, when S102 is performed to select the target error-correcting model corresponding to the obtained error-correcting type, an optional implementation that may be employed is: obtaining scene information of the text to be processed, where the obtained scene information may be a chat scene, a legal scene, a scientific and technological scene, a medical scene, etc.; selecting the target error-correcting model according to the error-correcting type and the obtained scene information.

In the present embodiment, when S102 is performed to obtain the scene information of the text to be processed, the scene information input by the user may be taken as the scene information of the text to be processed, or scene recognition may be performed on the text to be processed and then a recognition result may be taken as the scene information of the text to be processed.

In the present embodiment, when S102 is performed to select the target error-correcting model according to the error-correcting type and the obtained scene information, an optional implementation that may be employed is: taking the error-correcting models corresponding to the error-correcting types as candidate error-correcting models; selecting an error-correcting model corresponding to the obtained scene information from the candidate error-correcting models, as the target error-correcting model.

In other words, in addition to corresponding to different error-correcting types, the target error-correcting models selected in the present embodiment also correspond to different scene information. A sole target error-correcting model can be determined according to one error-correcting type and one piece of scene information of the text to be processed. Therefore, in the present embodiment, the target error-correcting model can be selected more accurately by combining the error-correcting type and the scene information, thereby further improving the accuracy of the obtained error-correcting result.

In addition, if the target error-correcting model corresponding to the error-correcting type cannot be selected by performing S102 in the present embodiment, a prompt message that error correction cannot be completed is returned to the user, and the error-correcting model corresponding to the error-correcting type is added later.

In the present embodiment, after the target error-correcting model is selected by performing S102, S103 processing the text to be processed using the target error-correcting model and regarding a processing result as an error-correcting result of the text to be processed is performed.

It may be appreciated that if only one target error-correcting model is selected by performing S102 in the present embodiment, a processing result of the target error-correcting model for the text to be processed is taken as the error-correcting result of the text to be processed when S103 is performed in the present embodiment.

In the present embodiment, if a plurality of target error-correcting models are selected by performing S102, the following optional implementation may be used when processing the text to be processed using the target error-correcting model by performing S103 to improve the orderliness of the plurality of target error-correcting models in correcting different errors in the text to be processed: determining an error-correcting order of the plurality of target error-correcting models; according to the determined error-correcting order, using the error-correcting models in turn to process the text to be processed, i.e., taking a processing result of a current target error-correcting model as an input to next target error-correcting model until the processing of the last target error-correcting model is completed.

In the present embodiment, when performing S103 to determine the error-correcting order of the plurality of target error-correcting models, it is possible to take an order of inputting the error-correcting types as the error-correcting order of the plurality of target error-correcting models, or possible to preset model priority levels of the error-correcting models to determine the error-correcting order of the plurality of target error-correcting models according to the preset model priority levels.

According to the method according to the present embodiment, the flexibility and accuracy of the text error correction can be enhanced on the premise of satisfying the user's different error-correcting demands by obtaining the error-correcting type of the text to be processed while obtaining the text to be processed, thereby using a target error-correcting model corresponding to the error-correcting type to process the text to be processed to obtain an error-correcting result.

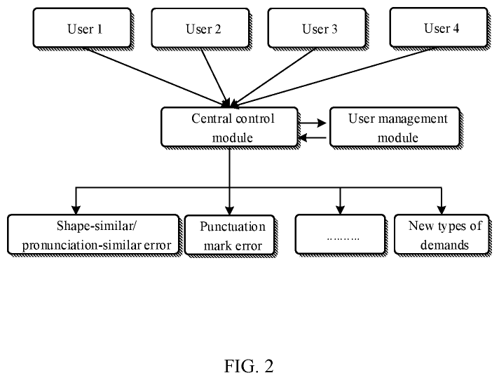

FIG. 2 illustrates a schematic diagram of a second embodiment according to the present disclosure.

As shown in FIG. 2, the present embodiment shows a schematic diagram of a platform for implementing the text error-correcting method. The platform in FIG. 2 includes a central control module and a user management module; on the one hand, the central control module is used to receive different users' error-correcting demands including a text to be processed and an error-correcting model; on the other hand, the central control module is used to invoke a corresponding target error-correcting model according to a processing result of the user management module to correct errors in the text to be processed; the user management module is used to manage different users' error-correcting demands, determine target error-correcting models corresponding to the error-correcting demands; if the error-correcting demand used by the user management module is a new type of demand, an error-correcting model corresponding to the new type of demand will be added later.

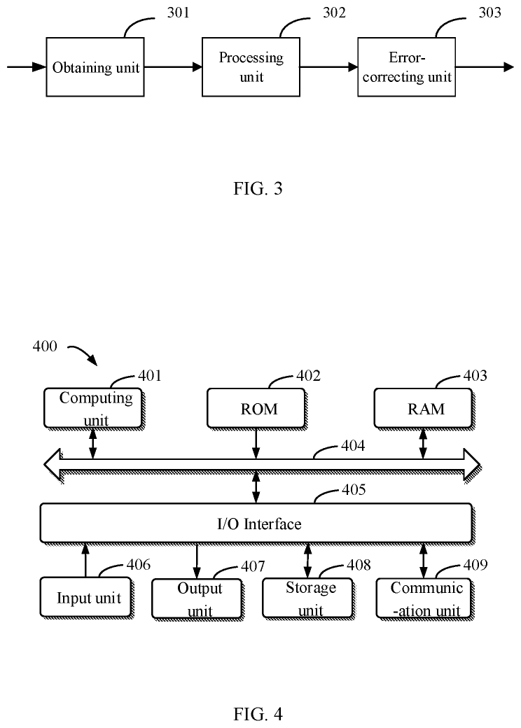

FIG. 3 illustrates a schematic diagram of a third embodiment according to the present disclosure. As shown in FIG. 3, a text error-correcting apparatus according to the present embodiment includes: an obtaining unit 301 configured to obtain a text to be processed, and an error-correcting type of the text to be processed; a processing unit 302 configured to select a target error-correcting model corresponding to the error-correcting type; an error-correcting unit 303 configured to process the text to be processed using the target error-correcting model, and regard a processing result as an error-correcting result of the text to be processed.

When obtaining the text to be processed, the obtaining unit 301 regards a text input by the user as the text to be processed, and or regards a text conversion result of a speech input by the user as the text to be processed.

While obtaining the text to be processed, the obtaining unit 301 may obtain the error-correcting type of the text to be processed. The obtained error-correcting type may be one type or multiple types. The error-correcting type obtained by the obtaining unit 301 may include at least one of shape-similar/pronunciation-similar error, punctuation mark error, collocation error, grammatical error etc.

When obtaining the error-correcting type of the text to be processed, the obtaining unit 301 may regard the error-correcting type input by the user or selected by the user as the error-correcting type of the text to be processed, or after recognizing the error-correcting type of the text to be processed, regard a recognition result as the error-correcting type of the text to be processed.

It may be appreciated that in the present embodiment, the obtaining unit 301 may use a pre-trained recognition model to implement recognition of the error-correcting type of the text to be processed. The recognition model can output the error-correcting type of the text according to the input text.

In the present embodiment, after the obtaining unit 301 obtains the text to be processed and the error-correcting type of the text to be processed, the processing unit 302 selects a target error-correcting model corresponding to the obtained error-correcting type. The target error-correcting model selected by the processing unit 302 is preset. Each target error-correcting model corresponds to an error-correcting type. Different target error-correcting models are only intended to correct one corresponding type of error in the text.

When selecting a target error-correcting model corresponding to the obtained error-correcting type, the processing unit 302 may employing the following optional implementation: taking an error-correcting model corresponding to the obtained error-correcting type as the target error-correcting model, according to a preset type-model correspondence relationship table.

It may be appreciated that the number of target error-correcting models selected by the processing unit 302 is equal to the number of error-correcting types of the text to be processed obtained by the obtaining unit 301. If there is one type of error-correcting type, one target error-correcting model will be selected by the processing unit 302. If there are a plurality of error-correcting types, a plurality of target error-correcting models will be selected by the processing unit 302, with each target error-correcting model corresponding to a different error-correcting type.

If the processing unit 302 determines that the same error-correcting type corresponds to a plurality of error-correcting models, the processing unit 302 randomly selects one error-correcting model from the plurality of error-correcting models as the target error-correcting model corresponding to the error-correcting type.

Since different texts will also correspond to different scenes, when error correction is performed for texts in different scenes, error-correcting results of the texts will also be related to the scenes corresponding to the texts.

In order to improve the accuracy of the selected target error-correcting model, when selecting the target error-correcting model corresponding to the obtained error-correcting type, the processing unit 302 may employ the following optional implementation: obtaining scene information of the text to be processed; selecting the target error-correcting model according to the error-correcting type and the obtained scene information.

When obtaining the scene information of the text to be processed, the processing unit 302 takes the scene information input by the user as the scene information of the text to be processed, or performs scene recognition on the text to be processed and then takes a recognition result as the scene information of the text to be processed.

When selecting the target error-correcting model according to the error-correcting type and the obtained scene information, the processing unit 302 may employ an optional implementation: taking the error-correcting models corresponding to the error-correcting types as candidate error-correcting models; selecting an error-correcting model corresponding to the obtained scene information from the candidate error-correcting models, as the target error-correcting model.

In other words, in addition to corresponding to different error-correcting types, the target error-correcting models selected by the processing unit 302 also correspond to different scene information. A sole target error-correcting model can be determined according to one error-correcting type and one piece of scene information of the text to be processed. Therefore, the processing unit 302 can select the target error-correcting model more accurately by combining the error-correcting type and the scene information, thereby further improving the accuracy of the obtained error-correcting result.

In addition, if the processing unit 302 fail to select the target error-correcting model corresponding to the error-correcting type, the processing unit 302 returns a prompt message that error correction cannot be completed to the user, and adds the error-correcting model corresponding to the error-correcting type later.

In the present embodiment, after the target error-correcting model is selected by the processing unit 302, the error-correcting unit 303 uses the selected target error-correcting model to process the text to be processed and regards a processing result as an error-correcting result of the text to be processed.

It may be appreciated that if the processing unit 302 only selects one target error-correcting model, the error-correcting unit 303 takes a processing result of the target error-correcting model for the text to be processed as an error-correcting result of the text to be processed.

In the present embodiment, if the processing unit selects a plurality of target error-correcting models, the error-correcting unit 303 may employ the following optional implementation when processing the text to be processed using the target error-correcting model to improve the orderliness of the plurality of target error-correcting models in correcting different errors in the text to be processed: determining an error-correcting order of the plurality of target error-correcting models; according to the determined error-correcting order, using the error-correcting models in turn to process the text to be processed, i.e., taking a processing result of a current target error-correcting model as an input to next target error-correcting model until the processing of the last target error-correcting model is completed.

When determining the error-correcting order of the plurality of target error-correcting models, the error-correcting unit 303 takes an order of inputting the error-correcting types as the error-correcting order of the plurality of target error-correcting models, or preset model priority levels of the error-correcting models to determine the error-correcting order of the plurality of target error-correcting models according to the preset model priority levels.

According to embodiments of the present disclosure, the present disclosure further provides an electronic device, a computer readable storage medium and a computer program product.

FIG. 4 illustrates a schematic diagram of an electronic device 400 for implementing embodiments of the present disclosure. The electronic device is intended to represent various forms of digital computers, such as laptops, desktops, workstations, personal digital assistants, servers, blade servers, mainframes, and other appropriate computers. The electronic device is further intended to represent various forms of mobile devices, such as personal digital assistants, cellular telephones, smartphones, wearable devices and other similar computing devices. The components shown here, their connections and relationships, and their functions, are meant to be exemplary only, and are not meant to limit implementations of the inventions described and/or claimed in the text here.

As shown in FIG. 4, the device 400 comprises a computing unit 401 that may perform various appropriate actions and processing based on a computer program stored in a Read-Only Memory (ROM) 402 or a computer program loaded from a storage unit 408 to a Random Access Memory (RAM) 403. In the RAM 404, there further store various programs and data needed for operations of the device 400. The computing unit 401, ROM 402 and RAM 403 are connected to each other via a bus 404. An input/output (I/O) interface 405 is also connected to the bus 404.

Various components in the electronic device 400 are connected to the I/O interface 405, including: an input unit 406 such as a keyboard, a mouse and the like; an output unit 407 including various kinds of displays and a loudspeaker, etc.; a storage unit 408 including a magnetic disk, an optical disk, and etc.; a communication unit 409 such as a network card, a modem, and a wireless communication transceiver, etc. The communication unit 409 allows the electronic device 400 to exchange information/data with other devices through a computer network such as the Internet and/or various kinds of telecommunications networks.

The computing unit 401 may be various general-purpose and/or special-purpose processing components with processing and computing capabilities. Some examples of computing unit 401 include, but are not limited to, Central Processing Unit (CPU), Graphics Processing Unit (GPU), various dedicated artificial intelligence (AI) computing chips, various computing units that run a machine learning model algorithm, Digital Signal Processing (DSP), and any appropriate processor, controller, microcontroller, etc. The computing unit 401 executes various methods and processes described above, such as the text error-correcting method. For example, in some embodiments, the text error-correcting method may be implemented as a computer software program, which is tangibly contained in a machine-readable medium, such as the storage unit 408. In some embodiments, part or all of the computer program may be loaded and/or installed on the device 400 via the ROM 402 and/or the communication unit 409. When the computer program is loaded into the RAM 403 and executed by the computing unit 401, one or more steps of the text error-correcting method described above may be executed. Alternatively, in other embodiments, the computing unit 401 may be configured in any other suitable manner (for example, with the aid of firmware) to execute the text error-correcting method.

Various implementations of the system and technology described above in the text may be implemented in a digital electronic circuit system, an integrated circuit system, a Field-Programmable Gate Array (FPGA), an Application Specific Integrated Circuit (ASIC), an Application Specific Standard Parts (ASSP), System on Chip (SOC), Complex Programmable Logic Device (CPLD), computer hardware, firmware, software and/or combinations thereof. The various implementations may include: implemented in one or more computer programs which may be executed and/or explained on a programmable system including at least one programmable processor; the programmable processor may be a dedicated or general-purpose programmable processor, may receive data and instructions from a storage system, at least one input device and at least one output device, and transmit the data and instructions to the storage system, the at least one input device and the at least one output device.

The computer program code for implementing the method of the subject matter described herein may be complied with one or more programming languages. These computer program codes may be provided to a general-purpose computer, a dedicated computer or a processor or controller of other programmable data processing apparatuses, such that when the program codes are executed by the processor or controller, the functions/operations prescribed in the flow chart and/or block diagram are caused to be implemented. The program code may be executed completely on a machine, partly on a machine, partly on a machine as an independent software packet and partly on a remote machine, or completely on a remote machine or server.

In the context of the subject matter described herein, the machine-readable medium may be any tangible medium including or storing a program for or about an instruction executing system, apparatus or device. The machine-readable medium may be a machine-readable signal medium or machine-readable storage medium. The machine-readable medium may include, but not limited to, electronic, magnetic, optical, electro-magnetic, infrared, or semiconductor system, apparatus or device, or any appropriate combination thereof. More detailed examples of the machine-readable storage medium include, an electrical connection having one or more wires, a portable computer magnetic disk, a hard drive, a Random-Access Memory (RAM), a Read-Only Memory (ROM), an Erasable Programmable Read-Only Memory (EPROM or flash memory), an optical fiber, a Portable Compact Disc Read-Only Memory (CD-ROM), an optical storage device, a magnetic storage device, or any appropriate combination thereof.

To provide for interaction with a user, the systems and techniques described here may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The systems and techniques described here may be implemented in a computing system that includes a back end component (e.g., as a data server), or that includes a middleware component (e.g., an application server), or that includes a front end component (e.g., a client computer having a graphical user interface or a Web browser through which a user may interact with an implementation of the systems and techniques described here), or any combination of such back end, middleware, or front end components. The components of the system may be interconnected by any form or medium of digital data communication (e.g., a communication network). Examples of communication networks include a Local Area Network (LAN), a Wide Area Network (WAN), and the Internet.

The computing system may include clients and servers. A client and server are generally remote from each other and typically interact through a communication network. The relationship of client and server arises by virtue of computer programs running on the respective computers and having a client-server relationship to each other. The server may be a cloud server, also referred to as a cloud computing server or a cloud host, and is a host product in a cloud computing service system to address defects such as great difficulty in management and weak service extensibility in a traditional physical host and VPS (Virtual Private Server). The server may also be a server of a distributed system, or a server combined with a block chain.

It should be understood that the various forms of processes shown above can be used to reorder, add, or delete steps. For example, the steps described in the present disclosure can be performed in parallel, sequentially, or in different orders as long as the desired results of the technical solutions disclosed in the present disclosure can be achieved, which is not limited herein.

The foregoing specific implementations do not constitute a limitation on the protection scope of the present disclosure. It should be understood by those skilled in the art that various modifications, combinations, sub-combinations and substitutions can be made according to design requirements and other factors. Any modification, equivalent replacement and improvement made within the spirit and principle of the present disclosure shall be included in the protection scope of the present disclosure.

What is claimed is:

1. A text error-correcting method, comprising:
obtaining a text to be processed, and an error-correcting type of the text to be processed;
selecting a target error-correcting model corresponding to the error-correcting type; and
processing the text to be processed using the target error-correcting model, and regarding a processing result as an error-correcting result of the text to be processed.

2. The method according to claim 1, wherein the selecting a target error-correcting model corresponding to the error-correcting type comprises:
obtaining scene information of the text to be processed; and
selecting the target error-correcting model according to the error-correcting type and the scene information.

3. The method according to claim 2, wherein the selecting the target error-correcting model according to the error-correcting type and the scene information comprises:
taking the error-correcting models corresponding to the error-correcting types as candidate error-correcting models; and
selecting an error-correcting model corresponding to the scene information from the candidate error-correcting models, as the target error-correcting model.

4. The method according to claim 1, wherein the processing the text to be processed using the target error-correcting model comprises:
determining an error-correcting order of a plurality of target error-correcting models; and
according to the error-correcting order, using the error-correcting models in turn to process the text to be processed.

5. The method according to claim 4, wherein the determining the error-correcting order of the plurality of target error-correcting models comprises:
taking an order of inputting the error-correcting types as the error-correcting order of the plurality of target error-correcting models; or
determining the error-correcting order of the plurality of target error-correcting models according to preset model priority levels.

6. An electronic device, comprising:
at least one processor; and
a memory communicatively connected with the at least one processor;
wherein the memory stores instructions executable by the at least one processor, and the instructions are executed by the at least one processor to enable the at least one processor to perform a text error-correcting method, wherein the method comprises:
obtaining a text to be processed, and an error-correcting type of the text to be processed;
selecting a target error-correcting model corresponding to the error-correcting type; and
processing the text to be processed using the target error-correcting model, and regarding a processing result as an error-correcting result of the text to be processed.

7. The electronic device according to claim 6, wherein the selecting a target error-correcting model corresponding to the error-correcting type comprises:
obtaining scene information of the text to be processed; and
selecting the target error-correcting model according to the error-correcting type and the scene information.

8. The electronic device according to claim 7, wherein the selecting the target error-correcting model according to the error-correcting type and the scene information comprises:
taking the error-correcting models corresponding to the error-correcting types as candidate error-correcting models; and
selecting an error-correcting model corresponding to the scene information from the candidate error-correcting models, as the target error-correcting model.

9. The electronic device according to claim 6, wherein the processing the text to be processed using the target error-correcting model comprises:
determining an error-correcting order of a plurality of target error-correcting models; and
according to the error-correcting order, using the error-correcting models in turn to process the text to be processed.

10. The electronic device according to claim 9, wherein the determining the error-correcting order of the plurality of target error-correcting models comprises:
taking an order of inputting the error-correcting types as the error-correcting order of the plurality of target error-correcting models; or
determining the error-correcting order of the plurality of target error-correcting models according to preset model priority levels.

11. A non-transitory computer readable storage medium with computer instructions stored thereon, wherein the computer instructions are used for causing a computer to perform a text error-correcting method, wherein the method comprises:
obtaining a text to be processed, and an error-correcting type of the text to be processed;
selecting a target error-correcting model corresponding to the error-correcting type; and
processing the text to be processed using the target error-correcting model, and regarding a processing result as an error-correcting result of the text to be processed.

12. The non-transitory computer readable storage medium according to claim 11, wherein the selecting a target error-correcting model corresponding to the error-correcting type comprises:
obtaining scene information of the text to be processed; and
selecting the target error-correcting model according to the error-correcting type and the scene information.

13. The non-transitory computer readable storage medium according to claim 12, wherein the selecting the target error-correcting model according to the error-correcting type and the scene information comprises:
taking the error-correcting models corresponding to the error-correcting types as candidate error-correcting models; and
selecting an error-correcting model corresponding to the scene information from the candidate error-correcting models, as the target error-correcting model.

14. The non-transitory computer readable storage medium according to claim 11, wherein the processing the text to be processed using the target error-correcting model comprises:
determining an error-correcting order of a plurality of target error-correcting models; and
according to the error-correcting order, using the error-correcting models in turn to process the text to be processed.

15. The non-transitory computer readable storage medium according to claim 14, wherein the determining the error-correcting order of the plurality of target error-correcting models comprises:
taking an order of inputting the error-correcting types as the error-correcting order of the plurality of target error-correcting models; or
determining the error-correcting order of the plurality of target error-correcting models according to preset model priority levels.
